(19) United States
(12) Patent Application Publication
(10) Pub. No.: US 2026/0358644 A1
(43) Pub. Date: Nov. 12, 2026

(54) ROTARY RHOMBOID PRISM BEAM COMBINER

(71) Applicant: Megawatt Lasers, Hilton Head Island, SC (US)

(72) Inventors: Ashley Charpentier, Hilton Head Island, SC (US); Scott Hamlin, Hilton Head Island, SC (US); Benjamin Hart, Bluffton, SC (US); Christopher Hardy, Hilton Head Island, SC (US); Alexander Likins, Hilton Head Island, SC (US)

(73) Assignee: Megawatt Lasers, Hilton Head Island, SC (US)

(21) Appl. No.: 19/456,572

(22) Filed: Jan. 22, 2026

Related U.S. Application Data
(60) Provisional application No. 63/748,680, filed on Jan. 23, 2025.

(51) Int. Cl. G02B 27/12

(52) U.S. Cl. CPC G02B 27/126

(57) ABSTRACT

Described herein is an optical beam combining device, and methods for making same, which consists of a transparent rhomboid prism and a motorized rotation stage. A plurality of beams of light on different axes from each other are sequentially directed toward the device and the rhomboid prism is rotated so that light enters one of its faces. The light is then guided to the opposite end of the rhomboid prism, which is centered on the axis of rotation, and escapes, such that all the beams on different axes heading into the prism escape out along the same axis.

### TECHNICAL FIELD

The subject matter disclosed herein is generally directed to laser resonators and other light sources that are manipulated so that beams of light or other radiation switch from one channel of energy or information to another. This disclosure falls within the field of optics, optoelectronics or optomechanics because of its applications for mechanical beam steering and beam combining.

### BACKGROUND

Many applications require high pulse repetition rate and high average power lasing devices. In the case of solid-state lasers, limitations in both repetition rate and average power arise due to thermal effects caused by stresses in the laser gain media or laser induced damage thresholds. To produce higher repetition rates and/or higher average power systems, laser engineers often combine the outputs of multiple resonators. In many cases, the laser beams must be combined so they are co-linear. Multiple methods have been employed by laser engineers to accomplish this, but for many applications, the best solution is a mechanical beam combiner.

Generic beam combiners are commonly used in the industry. For example, FIG. 1 shows an illustration from U.S. Pat. No. 5,999,555. FIG. 1 shows a current state of the art device. The device is a reflective mirror in the form of an optical wedge, mounted on a rotation stage. Multiple laser resonators sequentially emit beams which are reflected off mirrors and arrive at the rotating beam combiner. The wedge is controlled so that each beam is reflected, one at a time, down the shared output axis. Disadvantages of this concept include the optical complexity, long optical path length and alignment sensitivity of the optical wedge. Meanwhile, the current disclosure is distinct from this, because rather than a reflective wedge, or mirrored surface, the rotating beam combiner consists of a transparent optical rhomboid prism. As will be discussed in detail, infra, the embodiments of the current disclosure cannot be achieved by any combination or rearrangement of prior art.

FIG. 2 shows a prior effort used by laser manufacturers to combine multiple resonators. FIG. 2 depicts a common rotating beam combiner, which is a device that combines the output from multiple laser resonators onto the same beam path. The beam combiner is very simple, a disk (206) with a mirror (210) and a through-hole (208). The device is placed in the path of beams from two resonators (202 and 204) such that, as it rotates, first the beam from resonator 1 (204) is reflected by the mirror 212 onto the mirror on the rotating disk 210 (see, FIG. 2A), then the mirror moves out of the way and resonator 2 (202) shines a beam through the hole in the disk 208 (see, FIG. 2B). As the beam exits the disk through the hole (208), the beam path is colinear. The device functions as a sequential beam combiner that operates by rotating a reflective and transmissive object. Although commonly used, the path length for each resonator is different and this will result in different beam sizes for each resonator. Usually, the difference in path length is small, but with highly divergent resonators, the difference in the combined beam size can be substantial. The method shown in FIG. 2 is distinct from the present invention in three ways: extra optics are required, the maximum number of beams combined with a single disk is two, and the output beam quality is dependent on the divergence and optical path length of each resonator. The current disclosure is not limited in any of these respects.

What is needed in the art are improved, efficient ways of combining multiple resonators. Accordingly, it is an object of the present disclosure to provide an elegant method of combining multiple resonators that is simple, compact, inexpensive, and inherently insensitive to misalignment.

Citation or identification of any document in this application is not an admission that such a document is available as prior art to the present disclosure.

### SUMMARY

The above objectives are accomplished according to the present disclosure by providing an optical beam combining device, which consists of a transparent rhomboid prism and a motorized or mechanical rotation stage. A plurality of beams of light on different axes from each other are sequentially directed toward the device and the rhomboid prism is rotated so that light enters one of its faces. The light is then guided to the opposite end of the prism, which is centered on the axis of rotation, and escapes, such that all the beams on different axes heading into the rhomboid prism escape out along the same axis.

The current disclosure also provides methods for making an optical beam combining device, which consists of a transparent prism and a motorized rotation stage. A plurality of beams of light on different axes from each other are sequentially directed toward the device and the rhomboid prism is rotated so that light enters one of its faces. The light is then guided to the opposite end of the rhomboid prism, which is centered on the axis of rotation, and escapes, such that all the beams on different axes heading into the rhomboid prism escape out along the same axis.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a prior art device.

FIGS. 2A and 2B show another prior art device.

FIGS. 3A, 3B, and 3C show one embodiment of simplification of optical elements pursuant to the current disclosure. FIG. 3C shows the balancing feature and rotational stage.

FIG. 4 shows a transparent view of a rhomboid prism with parallel faces, displaying the path of a beam as it enters one face, reflects off the insides, and exits through the opposite face.

FIG. 5 shows different optical combinations that mimic the behavior of the rotating rhomboid prism.

FIG. 6 shows a depiction of the rhomboid prism of FIG. 4 from the output side; the same device is shown in each of its four positions, rotating to align with the beam from one resonator to the next.

FIGS. 7A, 7B, and 7C shows different variants of a standard beam combining resonator, shared output coupler before and after beam combinations.

FIGS. 8A, 8B, and 8C shows variations of using a single high reflective mirror with output coupler variations.

FIGS. 9A, 9B, and 9C shows embodiments of shared optical components without the presence of a beam combiner.

FIG. 10 shows an embodiment where the prism is used to distribute heat over a large volume of material.

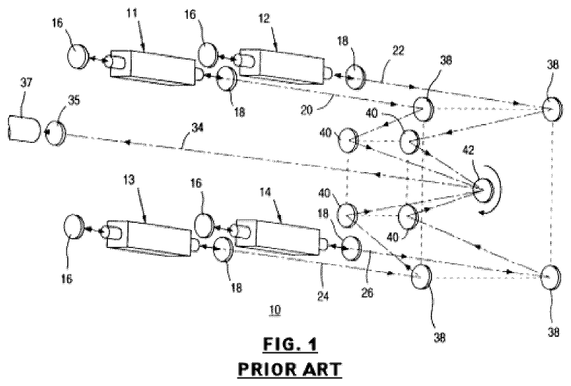

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g., given data set, art accepted standard, and/or with e.g., a given confidence interval (e.g., 90%, 95%, or more confidence interval from the mean), such as variations of +/−10% or less, +/−5% or less, +/−1% or less, and +/-0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g., mass, volume, dosage, concentration, and/or time period) needed to achieve one or more desired and/or stated result(s). For example, a therapeutically effective amount refers to an amount needed to achieve one or more therapeutic effects.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g., a web interface.

These further definitions are also provided:

Collimated beam: a beam of light whose rays are essentially parallel and do not have high beam divergence.

Diffuse reflection: the reflection of light from a surface such that an incident ray is reflected at many angles, rather than at just one angle.

Beam divergence: a measure for how fast a laser beam expands far from its focal point or beam waist.

Electro-optical components: devices designed to interact between the electromagnetic (optical) and the electric (electronic) state.

Flashlamp: an electrical arc lamp which creates intense brief bursts of bright light. Used as a pump source for lasers.

High reflectivity mirror: a mirror that reflects a high percentage, typically 99% or more of the light back through the resonator.

Housing: the structure or device that holds the parts of the laser system in place.

Ho:YAG: a single Yttrium Aluminum Garnet crystal doped with a small amount of trivalent Holmium (Ho). When used with flashlamp-pumping, Ho:YAG is often co-doped with small amounts of trivalent Chromium (Cr) and Thulium (Tm) as sensitizing ions. The co-doped material is often referred to as CTH:YAG. There are many wavelengths that CTH:YAG can lase at but the most common is 2130 nanometers. CTH:YAG lasers are commonly used for endourological applications.

Laser: a device that generates an intense beam of coherent monochromatic light (or other electromagnetic radiation) by stimulated emission of photons from excited atoms or molecules.

Laser diode: a semiconductor device similar to a light-emitting diode in which a diode pumped directly with electrical current can create lasing conditions at the diode's junction.

Laser medium: the source of optical gain within a laser.

Laser resonator: a chamber consisting of reflective surfaces and a laser amplification medium in which laser radiation can circulate and compensate optical power losses. Also called a laser cavity.

Laser rod: a gain media in the shape of a solid cylinder used in the generation of a laser beam.

MOPA: a master oscillator power amplifier (MOPA) is a laser system configuration consisting of a master laser which controls the frequency of the system and at least one amplifier which increases the output power.

Nd:YAG: a single Yttrium Aluminum Garnet crystal doped with a small amount of trivalent Neodymium. This is a common gain medium for solid-state lasers. There are many wavelengths that Nd:YAG can lase at but the most common is 1064 nanometers. Nd:YAG lasers are used for a myriad of applications.

Output coupler: partially transparent laser mirror, used for extracting output beams from laser resonators.

Optical gain: a measure of the strength of optical amplification.

Rhomboid prism: with regards to this application, solid optical element(s) with at least two parallel faces that translates the input beam from one path to another Pump chamber: a part of a lamp-pumped solid-state laser, used to direct the emission of the optical pump source into the laser gain media.

Pump source: the device which transfers energy from an external source into optical energy used to excite or optically pump the gain media, Examples include flashlamps, arc lamps, LEDs, and semiconductor lasers.

Q-switch: a fast optical switch used in lasers to create incredibly short, high-peak power pulses (nanoseconds) by modulating the laser's “Q” factor (resonator Quality).

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the rotary rhomboid prism beam combiners described herein can be presented as a combination kit. As used herein, the terms “combination kit” or “kit of parts” refers to the tools, equipment, compounds, compositions, and any additional components that are used to package, sell, market, deliver, and/or administer the combination of elements or a single element, such as the rotary rhomboid prism beam combiners contained therein. Such additional components include, but are not limited to, packaging, blister packages, boxes, and the like. When one or more of the tools, equipment, compounds, compositions, and any additional components described herein or a combination thereof (e.g., parts of rotary rhomboid prism beam combiners contained in the kit are provided simultaneously, the combination kit can contain the rotary rhomboid prism beam combiners in a single formulation, such as a complete rotary rhomboid prism beam combiner system or in separate embodiments. When the tools, equipment, compounds, compositions, and any additional components described herein or a combination thereof and/or kit components are not provided simultaneously, the combination kit can contain each rotary rhomboid prism beam combiner in separate embodiments. The separate kit components can be contained in a single package or in separate packages within the kit.

In some embodiments, the combination kit also includes instructions printed on or otherwise contained in a tangible medium of expression. The instructions can provide information regarding the content of the tools, equipment, compounds, compositions, and any additional components, indications for use, assembly instructions, and/or recommended uses for the rotary rhomboid prism beam combiners contained therein. In some embodiments, the instructions can provide directions and protocols for using the rotary rhomboid prism beam combiners. In some embodiments, the instructions can provide one or more embodiments of the methods for making rotary rhomboid prism beam combiners such as any of the methods described in greater detail elsewhere herein.

This disclosure provides an elegant method of combining multiple resonators that is simple, compact, inexpensive, and inherently insensitive to misalignment. Meanwhile, there is also demand for multi-wavelength laser systems. In one embodiment of the disclosure, outputs may be switched between different individual beams with different characteristics such as wavelength or pulse duration. Switching could occur either rapidly, so that the different laser characteristics can be sequenced, or a specific laser beam could be selected for a procedure or mission. One embodiment of this disclosure is a device that allows sharing drive electronics, cooling system, and beam delivery components allowing a compact, efficient, and inexpensive multifunction laser system. Further, a complex optical design can take considerable time to align. This disclosure reduces the number of optical elements and provides a compact and optically simple design, simplifying the alignment procedure.

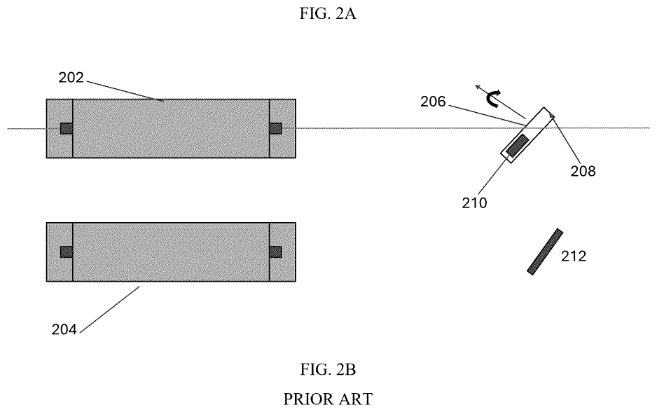

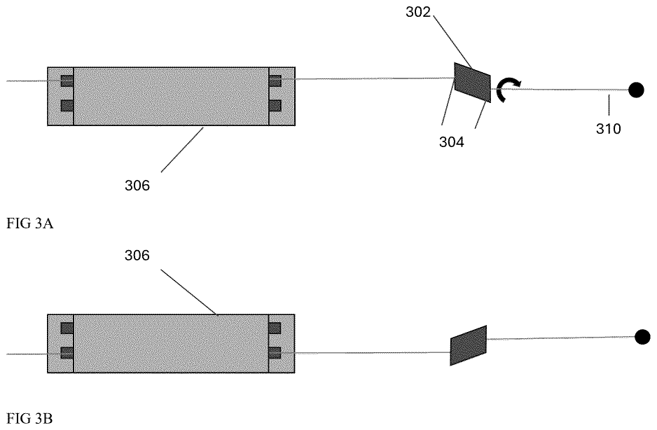

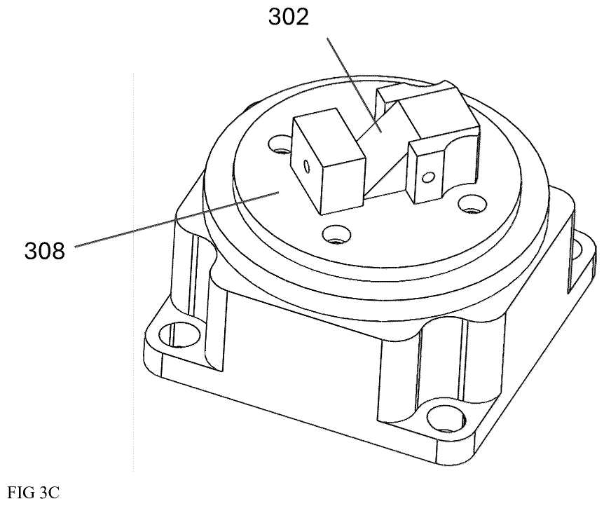

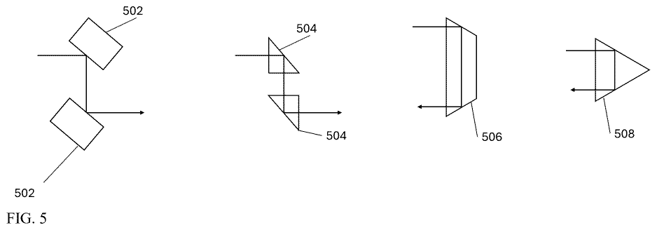

FIG. 3 shows one embodiment of single, rotating, optical rhomboid prism 302 with parallel faces 304 employed with numerous solid state flashlamp pumped lasers 306. The rhomboid prism operates like a periscope, displacing the light from its original axis onto a new one by reflecting rays off two inner parallel reflective surfaces. Unlike a periscope, this rhomboid prism rotates about the center of the output face, so that the input face swings around until it is aligned in front of the next resonator cavity. During use, the device operates as a rotary selector switch for the various laser resonators, see FIG. 3A and FIG. 3B. The rhomboid prism will provide a solid state, alignment insensitive, single component, beam combiner for multiple resonators, reducing the maintenance and cost required to operate a plurality of lasers. In the embodiment shown in FIG. 3, all four of the optical path lengths are equal. This is an improvement over the prior art illustrated in FIG. 2 where the optical path lengths are unequal. While FIG. 3 only shows two optical path lengths, the current disclosure is not so limited and any number of optical paths may be combined via the current disclosure. Two paths are illustrated for simplicity. Further, see FIG. 5, other optical devices that act similar to a Rhomboid Prism, which may be incorporated herein, include but are not limited to two reflecting mirrors 502, two turning prisms 504, a 180° turning prism 506, and a 180° porro prism 508.

In one embodiment, a rhomboid prism held by a motorized rotation stage, which couples beams from four flashlamp pumped solid state lasers to a common, collinear output. This laser system quadruples the rate of fire, or repetition rate, over that of a single, power-limited laser.

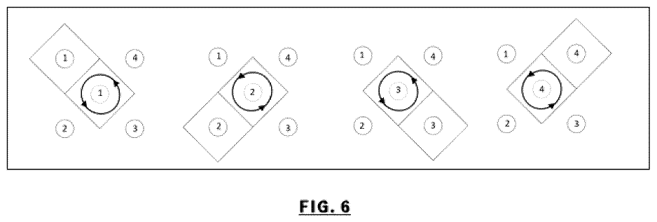

Referring to FIG. 3, beam combiner 302 may be a rhomboid prism held on a motorized rotation stage 308. The rhomboid prism may be made of transparent glass, ceramic, or crystal and may have three pairs of parallel faces. However, the current disclosure is not so limited and more or less pairs of parallel faces, or non-parallel face orientations, are hereby disclosed. The rhomboid prism guides the beam through reflection from the axes established by resonators to the common output axis 310. The rhomboid prism is inherently insensitive to misalignment across three translational and two rotational axes of motion. Motorized rotation stage 308 rotates the rhomboid prism so that its front face is centered on the optical axis of one of the resonators. When that resonator is activated, the beam enters the rhomboid prism and then exits the rhomboid prism along the common output axis. Then the rhomboid prism rotates to another resonator and its pulse is coupled to the common output axis. During operation, the rhomboid prism rotates to each position like a rotary selector switch. See FIG. 6. This rotation can be either continuous or intermittent.

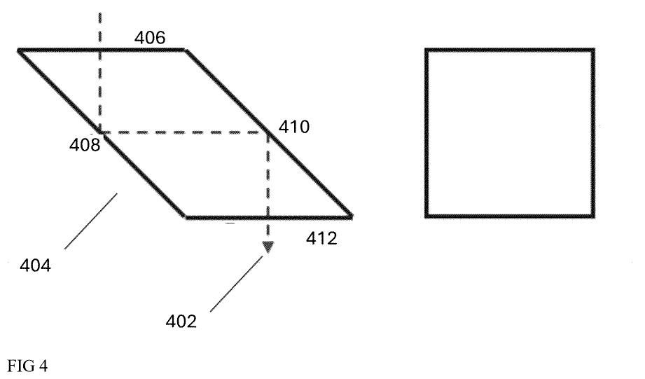

FIG. 4 shows a beam path 402 through a rhomboid prism 404. One pair of parallel prism faces serves as the entry and exit portal for the beam, another pair serves as reflectors. In this embodiment, the beam enters the rhomboid prism at the center of the entry face 406 and is orthogonal to the entry face. It travels through the glass and is reflected 90 degrees when it reaches the diagonal face 408. The beam then propagates through the inside of the prism to its boundary 410 and is reflected again, 90 degrees, so that it is centered on and orthogonal to the exit face 412 of the prism. The light exits the prism on an axis parallel to its entry. The angle of incidence of the beam with respect to the reflecting surfaces is 45 degrees for a turning angle of 90 degrees in FIG. 4; however, the angle of incidence does not have to be 45 degrees.

The rhomboid prism is held in place by mounting apparatus on the motorized rotation stage 308, see FIG. 3C. It is oriented so that the exit face is orthogonal to and centered on the axis of rotation. This axis of rotation is the common axis to which all lasers are coupled. In this embodiment, all the resonators are arranged so their optical axes are parallel to the common axis and equidistant from the optical axis. In this way, each resonator is positioned so that the rhomboid prism can swing its entry face until it is centered on the resonator axis, which will align it with the common output axis.

The rhomboid prism is also less complex than prior art. By providing a beam combiner that is constructed using a rhomboid prism, the problem of coupling parallel beams is simplified. The rhomboid prism collects each of the parallel beams through internal reflection. Therefore, no additional mirrors are required to redirect multiple beams to a final combining element such as in previous designs. This reduces the required number of optical elements to one. Since there is only one element, the cost of mounting and the labor of aligning several mirrors is eliminated.

As shown in FIG. 3, the rhomboid prism is an improvement over prior art for managing angular misalignment. The light entering the rhomboid prism is parallel to the beam path exiting the rhomboid prism. When light reflects off a flat surface, the angle of escape is equal in magnitude to the angle of arrival. This effect is known as the Law of Reflection, and it means that the angle by which a mirror is adjusted will double the angle by which the light is reflected. In practice, the result is that reflective surfaces are quite sensitive to misalignment. Rhomboid prisms offer a unique advantage during alignment, because as the first reflection angle increases, the second reflection angle increases equally. The effect cancels out, thus rhomboid prisms are relatively insensitive to alignment.

In a still further embodiment, the current disclosure may use six laser resonators, arranged in a circle about the common output axis, rather than merely four. This would result in a multiplication of the peak power by a factor of six. This embodiment is included to demonstrate that the number of coupled beam sources is arbitrary and not limited by the invention.

The current disclosure has myriad possible applications:
a Ho:YAG laser for lithotripsy and Benign Prostatic Hyperplasia (BPH). Currently systems are offered with 1, 2, 3, and 4 resonators, each utilizing a separate pump chamber. The beams are typically combined using a mechanical device such as a rotating mirror. The innovation could greatly simplify the design of these systems by using a single module for multiple pump chambers. Since the beams would be parallel and close to each other, a single lens could be used to focus into a fiber optic with no moving optics. Additionally, the innovation would extend the operational envelope by allowing all resonators to be synchronized, significantly increasing the output energy or asynchronous, significantly increasing the pulse rate frequency.
An example of a multiple wavelength system might be a Ho:YAG/Nd:YAG laser for urological applications. Ho:YAG lases at 2.13 μm and Nd:YAG at 1.06 μm. Since the water absorption is very different for the two wavelengths, a system that allows operation at either or both wavelengths would have new applications. Two wavelengths are used for this description for the sake of simplicity, however, any number of laser wavelengths could be used with respect to the present disclosure.
Some lasers require redundancy. If multiple lasers were incorporated into a system using the beam combiner, and one of the lasers failed or degraded, the other resonator(s) could be used as redundant backups by selecting a functional resonator with the beam combiner. The beam combiner allows both the primary laser and backup laser(s) to propagate through the same optical system. This is particularly useful for space, some military missions, and medical laser systems.

An example of a system that could benefit from the rotary rhomboid prism beam combiner is a medical laser for urological applications. For example, urological procedures often use a single Ho:YAG resonator with pulse energies up to about 4 Joules. Typical flashlamp-pumped Ho:YAG lasers are limited to about 40 Watts of average power. Operation at higher average power with a single resonator is possible, but the beam quality is quickly degraded. Using a beam combiner to combine multiple resonators allows for operation at much higher average power and repetition rates than is possible with a single resonator. U.S. Pat. No. 5,999,555 describes a method to combine multiple beams; however, the rotary rhomboid prism beam combiner is a simpler method and is much easier to implement and maintain.

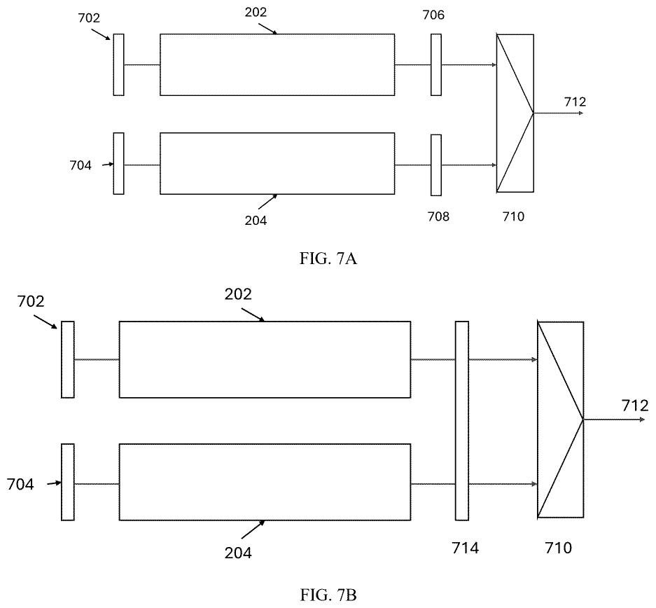

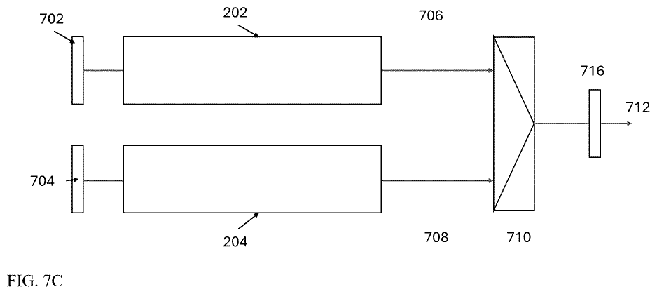

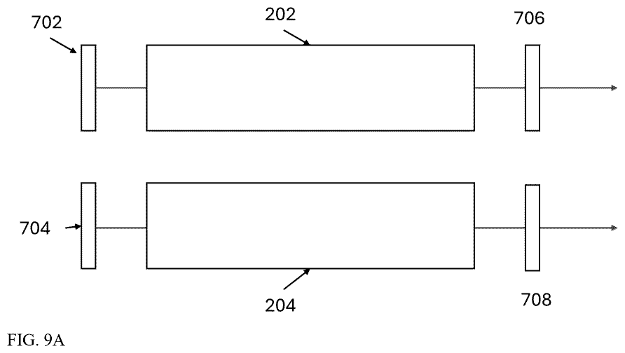

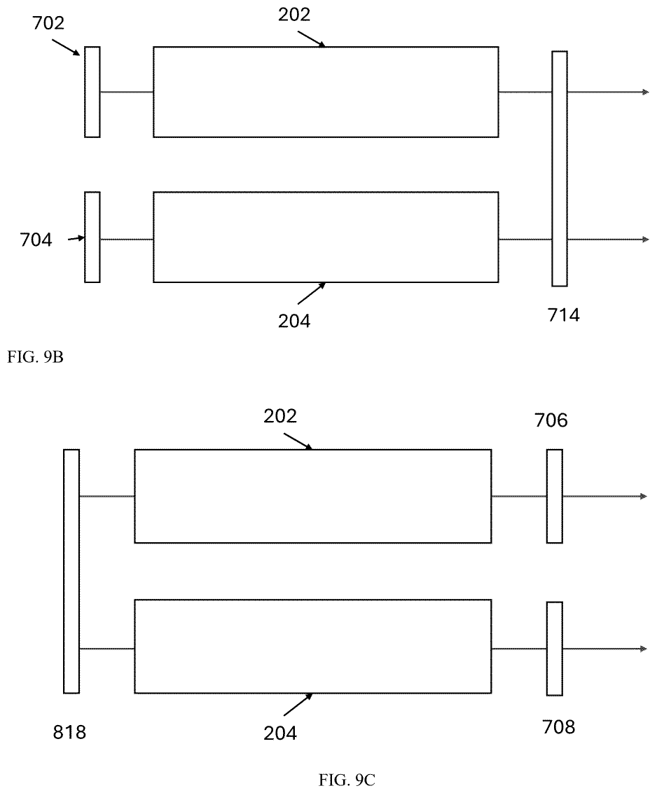

By nature of using the rotary rhomboid prism beam combination method, other optical simplifications arise as different embodiments. Note that any shared components may be placed either before or after beam combination A standard resonator with a beam combiner would be similar to FIG. 7A, where each resonator (202 and 204) corresponds with an output coupler (702 and 704) and an HR mirror (706 and 708) before entering the beam combiner (710) and having the resultant laser beam 712. Drawings are simplified to show two resonators and a beam combiner 710 to demonstrate this concept. Sharing components is made possible with the presence of the beam combiner. Because the rotary rhomboid prism beam combination method is compact in design, the optics may be shared without the necessity of a longer beam length. Note that the use of shared optics is not limited to being used with the beam combination method of this disclosure. Shared components without beam combination can be seen in FIGS. 9A, 9B, and 9C. FIG. 9B shows a combined output coupler and FIG. 9C shows a combined high-reflectivity resonator mirror.

### Shared Output Coupler

The integration of a shared output coupler for the multitude of resonators can offer several advantages. Firstly, it simplifies the optical setup by reducing the number of components required. Instead of having individual output couplers for each resonator, a single output coupler can be strategically positioned to extract laser beams from all resonators simultaneously. This consolidation leads to a more compact and streamlined module design, which is advantageous for space-constrained environments or portable applications.

Secondly, the shared output coupler facilitates efficient optical alignment. Aligning multiple output couplers individually can be challenging and time-consuming. With a shared output coupler, the alignment process becomes more straightforward, ensuring uniform output characteristics across all resonators.

By having a multitude of resonators share a singular output coupler, this method not only allows for the ease of aligning the lasing devices to the highest output power, but it allows for the assurance that the outputs from all the beams are parallel. In order for the beam combiner to have a coaxial beam output, each resonator output must be parallel to each other.

Similar to the standard resonator setup described in FIG. 7A, the rhomboid prism method of beam combination allows for further simplification by having a single output coupler (714) before the rhomboid prism, as shown in FIG. 7B or a single output coupler (716) after the rhomboid prism as shown in FIG. 7C. Additionally, the rotary rhomboid prism may be coated so that it will act as an output coupler, further simplifying the necessary number of optics in the system.

### Shared High Reflectivity Mirror

Incorporating a shared HR mirror within the laser module provides several advantages. Firstly, it reduces complexity and assembly time by eliminating the need for multiple individual mirrors within each resonator. The shared HR mirror serves as a common reflector for all resonators, simplifying the optical configuration and ensuring efficient utilization of optical components.

Secondly, the shared HR mirror facilitates precise optical alignment. Aligning multiple individual mirrors can be challenging and may result in misalignment issues. By using a shared HR mirror, the alignment process becomes more straightforward, leading to uniform beam properties across all resonators. Additionally, the shared HR mirror contributes to the overall compactness and cost-effectiveness of the laser module by minimizing the number of optical components required.

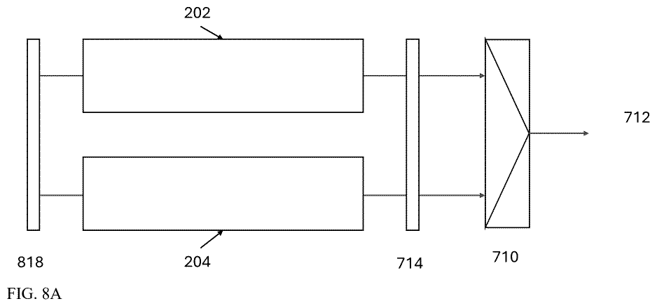

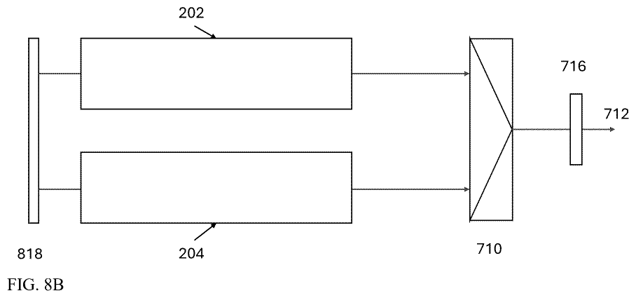

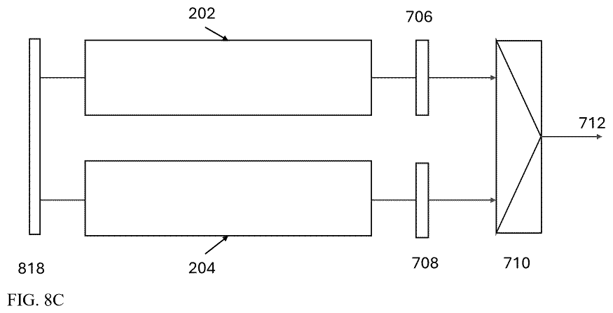

Ideally, a shared Output Coupler would be used in conjunction with a shared High Reflector (818) as can be seen in FIGS. 8A and 8B. However, in some cases it is more advantageous to use a resonator comprised of a shared Output Coupler or a shared High Reflector with individual mirrors for the second resonator mirror as is shown in FIG. 8C. This configuration is preferred for different reasons. First, for resonator stability, the high reflectivity mirrors might have a radius of curvature. Second, to compensate for manufacturing tolerances in the laser rods, individual alignment might be required. Third, if the beam combiner is used to combine resonators that are operating at different wavelengths, the high reflectivity resonator mirrors may be reflective at specific wavelengths that might be different for each resonator. For example, if the beam combiner was being used to combine Alexandrite, Nd:YAG, Ho:YAG, and Er:YAG resonators, individual high reflectivity mirrors at 755, 1064, 2130, and 2940 nm might be used. A fourth reason might be for individually optimizing the high reflectivity mirror design for each resonator. It is possible to engineer a complicated thin film coating stack that performs at multiple wavelengths, but complicated designs often have lower Laser Induced Damage Thresholds (LIDT) and compromised performance.

### Shared Electro-Optical Elements

Integrating shared electro-optical components, such as optical modulators, phase shifters, or frequency converters, within the laser module offers several benefits. Firstly, it enhances the functionality and versatility of the module by enabling precise modulation and manipulation of the laser beams. These components can be used to control parameters such as beam intensity, polarization, or wavelength, expanding the range of applications for which the module can be used.

Secondly, sharing electro-optical elements among multiple resonators reduces redundancy and optimizes resource utilization, leading to improvements in size, weight, complexity and costs. Instead of having separate components for each resonator, shared components can be strategically positioned in the optical path to serve multiple resonators simultaneously. This simplifies maintenance and servicing.

Additionally, centralizing control mechanisms for shared electro-optical components ensures synchronized operation across all resonators, maintaining coherence and consistency in the combined laser output. Centralized control enhances the reliability and performance of the laser module, making it suitable for demanding applications where precision and stability are critical.

Additionally, the beam combining prism 404 can act as an active optical element, for example the rhomboid prism could be fabricated from a material that alters beam characteristics such as a saturable absorbing material (passive Q-switch), non-linear optic such as frequency doubling crystals, acousto-optical device, electro-optical devices, etc. In addition, the beam combining prism could also act as a shared output coupler if a partial reflector coating was deposited on one or more faces of the prism. The rotating beam combining prism may also act as a mechanical Q-switch by using a rapid rate of rotation essentially creating a shutter for the beams as the prism rotates, storing energy in the laser rod and releasing it in a very short pulse duration.

In another embodiment, the disclosed beam combiner is utilized in a system configured to distribute thermally generated heat over an enlarged surface area and/or volume of a laser gain medium, thereby enabling increased average output power. U.S. Pat. Nos. 4,833,682 and 4,890,289 to Basu and Byer describe distributing heat by imparting translational and rotational relative motion to a gain structure such that a selectively pumped region is cyclically moved with respect to the remainder of the lasant material, thereby distributing pump-induced heat throughout the gain material to inhibit thermally induced birefringence and gain non-uniformity.

The present disclosure provides a comparable heat-distribution result; however, in contrast to the foregoing teachings, the gain medium remains stationary during operation. Maintaining a fixed gain medium advantageously simplifies fabrication and system integration.

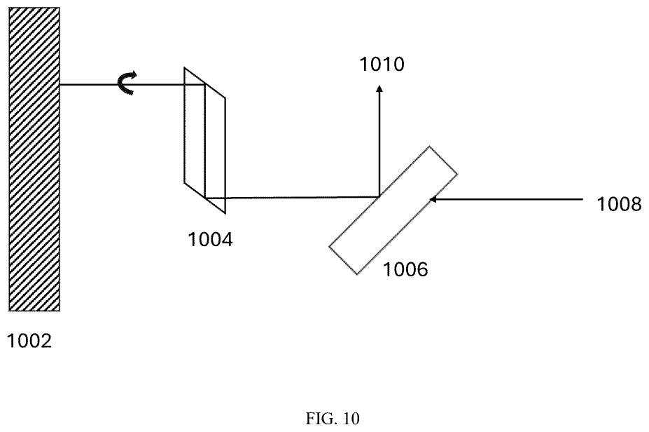

Referring to FIG. 10, a laser system is illustrated in which 1002 denotes a gain medium, preferably formed as a thin disk or a plurality of thin disks arranged in a stack. 1004 denotes the Rotary Rhomboid Prism Beam Combiner as disclosed herein. 1006 denotes a beam splitter. 1008 denotes pump radiation, preferably generated by a laser pump source such as an array of semiconductor lasers. 1010 denotes an output laser beam.

In one non-limiting application, the system is configured as a high-repetition-rate glass laser. Because glass exhibits relatively low thermal conductivity, removal of heat from a locally pumped region is inefficient and repetition rate is thereby limited. By distributing optical pumping and/or lasing over a larger region of the gain medium, heat density is reduced and the achievable repetition rate is correspondingly increased, in some embodiments by orders of magnitude.

In a further non-limiting example, the gain medium 1002 comprises erbium-doped phosphate glass (Er:Glass), which is operable to lase at an eye-safer wavelength of approximately 1540 nm. Er:Glass lasers are useful for remote-sensing applications, but conventional configurations are typically limited to repetition rates on the order of a few tens of pulses per second. The present distribution approach reduces thermal loading per unit area and therefore enables substantially higher pulse repetition frequencies.

During operation of the embodiment of FIG. 10, Er:Glass is preferably pumped with pump radiation 1008 in a wavelength band from about 900 nm to about 1000 nm. The pump radiation 1008 propagates through the beam splitter 1006 and through the Rotary Rhomboid Prism Beam Combiner 1004, which is arranged to function as a pump-distribution optic. The distributed pump radiation then enters the gain medium 1002 and excites ytterbium ions (Yb) co-doped within the Er:Glass as sensitizers. Energy absorbed by the Yb ions is transferred to erbium ions (Er), thereby producing a population inversion suitable for lasing at approximately 1540 nm.

In certain embodiments, one or more surfaces of the gain medium 1002 are provided with thin-film coatings configured to form at least a portion of an optical resonator at the lasing wavelength. In one embodiment, a saturable absorber is additionally coupled to, or integrated with, the gain medium to enable passive Q-switching. The resulting laser output 1010 at approximately 1540 nm exits the gain medium 1002, passes through the Rotary Rhomboid Prism Beam Combiner 1004, and is reflected by the beam splitter 1006 for delivery as the system output.

In another embodiment, the current disclosure may use nested laser resonators and rhomboid prism beam combiners.

Various modifications and variations of the described methods, compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. An optical beam combining device comprising:
a transparent rhomboid prism;
a rotation stage;
wherein a plurality of beams of light on different axes from each other are sequentially directed toward the optical beam combining device and the rhomboid prism is rotated so that the plurality of beams of light enters one face of the transparent rhomboid prism;
wherein the plurality of beams of light are guided to an opposite end of the transparent rhomboid prism, which is centered on an axis of rotation, and the plurality of beams of light escape, such that all of the plurality of beams of light on different axes heading into the transparent rhomboid prism escape out along the same axis.

2. A method for making an optical beam combining device comprising:
combining a transparent rhomboid prism and a rotation stage;
introducing a plurality of beams of light on different axes sequentially directed toward the device;
rotating the rhomboid prism so that light enters one of its faces;
guiding the plurality of light beams to an opposite end of the transparent rhomboid prism, which is centered on the axis of rotation;
wherein the plurality of light beams escape such that all the plurality of light beams on different axes heading into the transparent rhomboid prism escape out along the same axis.

3. A method of combining a plurality of beams from spatially separated light sources onto a single collinear path by sequentially transmitting the plurality of beams through a rotated optical rhomboid prism.

4. The method of claim 3, further comprising incorporating beam combining devices for use with laser sources and laser light including, but not limited to, solid state lasers, diode pumped lasers, semiconductor lasers, fiber lasers or any other laser that is obvious to an expert in the trade.

5. The method of claim 4, further comprising incorporating beam combining devices for use with laser medical devices.

6. The method of claim 4, further comprising beam combining devices for use with Solid-State laser gain media including Ho:YAG, Er:YAG, Nd:YAG, Er:Glass, Ruby, or Alexandrite and/or combinations of the above.

7. The method of claim 6, further comprising beam combining devices for use in urology and endourology.

8. The method of claim 7, further comprising beam combining devices for use in lithotripsy or Benign Prostate Hyperplasia treatments.

9. The method of claim 3, further comprising beam combining with multiple wavelengths.

11. The method of claim 3, further comprising beam combining devices for use in laser material processing.

12. The method of claim 11, further comprising beam combining devices for use in laser peening, drilling and/or welding.

13. An optical beam combining device of claim 1, further comprising utilizing at least one additional laser resonator as a backup to activate when at least one other resonator fails or degrades.

14. An optical beam combining device of claim 1, employed in space, military, or medical applications.

15. An optical beam combining device of claim 1, further comprising multiple wavelength resonators operated independently, simultaneously or sequentially.
